(19) United States
(12) Patent Application Publication
(10) Pub. No.: US 2026/0281624 A1
(43) Pub. Date: Sep. 17, 2026

(54) SPEAKER

(71) Applicant: AAC Microtech (Changzhou) Co., Ltd., Changzhou City (CN)

(72) Inventors: Yang Shi, Changzhou (CN); Ronglin Linghu, Changzhou (CN)

(21) Appl. No.: 19/305,780

(22) Filed: Aug. 21, 2025

Related U.S. Application Data
(63) Continuation of application No. PCT/CN2025/082608, filed on Mar. 14, 2025.

(51) Int. Cl. H04R 9/02; H04R 7/18; H04R 9/04; H04R 9/06

(52) U.S. Cl. CPC H04R 9/025; H04R 7/18; H04R 9/045; H04R 9/06; H04R 2400/11

(57) ABSTRACT

The present disclosure discloses a speaker including a frame, a vibration system including a diaphragm and a coil, a magnet system including a bottom yoke, a main magnet disposed on a surface of the bottom yoke facing the diaphragm with a first through hole penetrating thereon along the vibration direction, a magnetic member disposed on the bottom yoke and surrounded by the main magnet so as to form an installation gap; and a side magnet surrounding the main magnet for forming a magnetic gap in which the coil is inserted. The speaker in the present disclosure has stronger magnetic field and higher acoustic quality.

### FIELD OF THE PRESENT DISCLOSURE

The present disclosure relates to electric-acoustic conversion technologies, especially relates to a speaker applied in portable mobile terminals.

### DESCRIPTION OF RELATED ART

Speaker is a transducer that converts the electrical signal into acoustic signal. Commonly, the speaker includes a frame, a magnet system including a yoke and magnet mounted on the yoke, and a vibration system including a diaphragm and a coil attached to the diaphragm. The magnet and the coil interact to drive the diaphragm to vibrate for generating sound.

In related art, the magnet system includes a main magnet disposed on the yoke and a side magnet surrounding the main magnet for forming a magnetic gap in which the coil is inserted. However, the magnet system generally includes one single main magnet. And, the single main magnet and the side magnet are magnetized along opposite direction, which may result magnetic flux leakage and thereby reduce the acoustic quality of the speaker.

Therefore, it is necessary to provide an improved speaker to overcome the problems mentioned above.

### SUMMARY OF THE INVENTION

One object of the present disclosure is to provide a speaker with stronger magnetic field and higher acoustic quality.

The speaker includes a frame; a vibration system, including: a diaphragm mounted on the frame; and a coil fixed on the diaphragm; a magnet system mounted on the frame, configured to drive the diaphragm to vibrate along a vibration direction for generating sound signal, including: a bottom yoke; a main magnet disposed on a surface of the bottom yoke facing the diaphragm, including a first through hole penetrating thereon along the vibration direction; a magnetic member disposed on the bottom yoke, surrounded by the main magnet so as to form an installation gap; and a side magnet surrounding the main magnet for forming a magnetic gap in which the coil is inserted.

As an improvement, the magnetic member is made of permanent magnet or magnetically conductive material.

As an improvement, the magnetic member is made of permanent magnet; the main magnet is magnetized along a direction opposite to both magnetization directions of the magnetic member and the side magnet.

As an improvement, the main magnet is magnetized along the vibration direction.

As an improvement, the magnet system includes a main magnetic plate stacked on a surface of the main magnet facing the diaphragm.

As an improvement, the main magnetic plate is rectangular, and disposed on a surface of the magnetic member facing the diaphragm.

As an improvement, the main magnetic plate includes a main body fixed on the main magnet, a step portion depressed from a surface of the main body facing the diaphragm towards the bottom yoke, and a second through hole penetrating the step portion along the vibration direction; the magnetic member is opposite to the second through hole and extends into the second through hole; the second through hole is connected with the installation gap.

As an improvement, a surface of the step portion facing the diaphragm is aligned with a surface of the magnetic member facing the diaphragm.

As an improvement, a width d of the installation gap satisfies the following condition: 0 mm≤d≤5 mm.

As an improvement, further including a side magnet plate disposed on a surface of the side magnet facing the diaphragm; a surface of the side magnetic plate closer to the diaphragm is fixed on the frame.

As an improvement, the diaphragm includes a suspension portion in a rectangular ring shape, a fixation portion extended from an outer edge of the suspension portion, a vibration portion extended inwardly from an inner edge of the suspension portion, and a central portion fixed on a surface of the vibration portion facing the main magnet; the fixation portion is mounted on a surface of the frame away from the bottom yoke; the coil is fixed on a surface of the central portion facing the bottom yoke

### BRIEF DESCRIPTION OF THE DRAWINGS

The present disclosure will hereinafter be described in detail with reference to an exemplary embodiment. To make the technical problems to be solved, technical solutions and beneficial effects of present disclosure more apparent, the present disclosure is described in further detail together with the figures and the embodiment. It should be understood the specific embodiments described hereby is only to explain this disclosure, not intended to limit this disclosure.

FIG. 1 is an isometric view of a speaker in accordance with an exemplary embodiment of the present disclosure.

FIG. 2 is an exploded view of the speaker in FIG. 1.

FIG. 3 is a cross-sectional view of the speaker taken along line A-A in FIG. 1.

FIG. 4 is a cross-sectional view of the speaker taken along line B-B in FIG. 1.

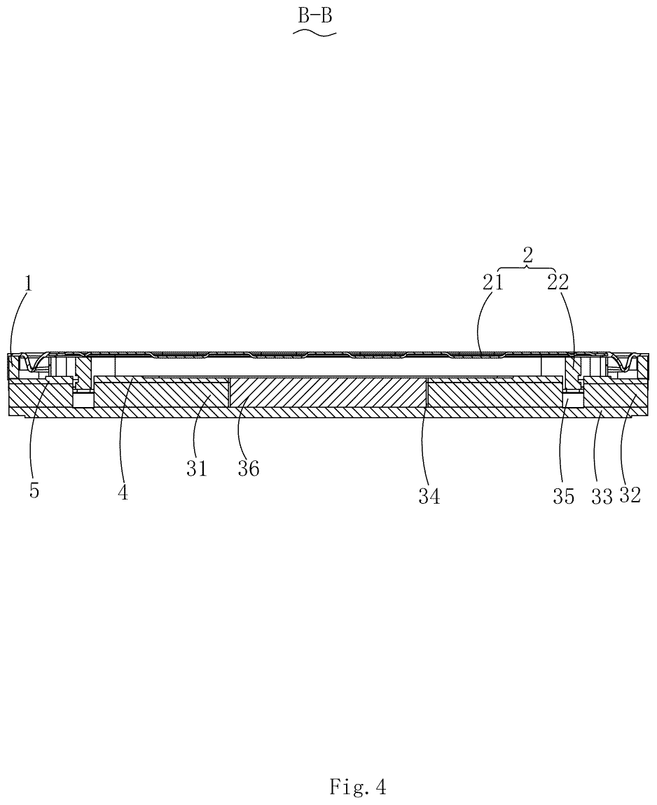

FIG. 5 is an enlarged view of part C in FIG. 1.

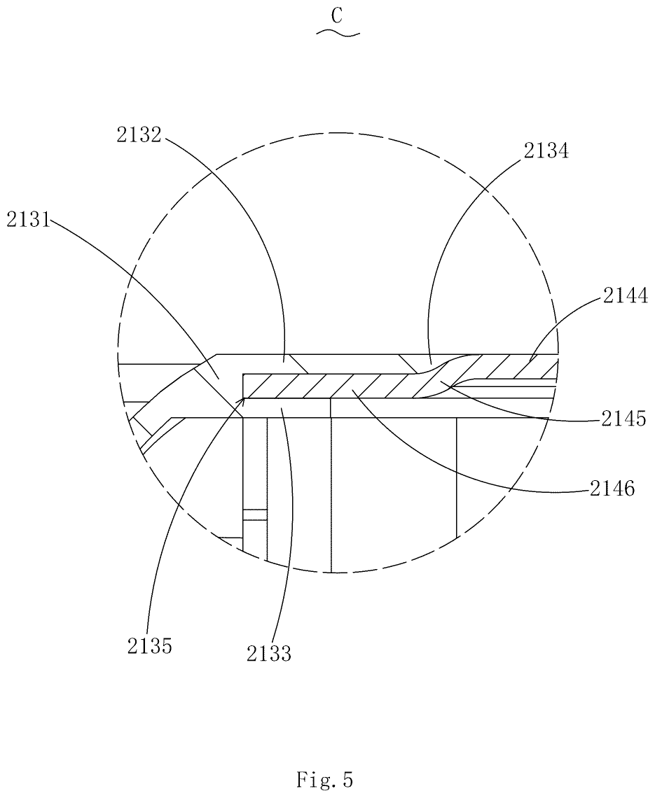

FIG. 6 is an isometric view of a central portion of the speaker in FIG. 1.

### DETAILED DESCRIPTION OF THE EXEMPLARY EMBODIMENT

The present disclosure will hereinafter be described in detail with reference to an exemplary embodiment. To make the technical problems to be solved, technical solutions and beneficial effects of the present disclosure more apparent, the present disclosure is described in further detail together with the figure and the embodiment. It should be understood the specific embodiment described hereby is only to explain the disclosure, not intended to limit the disclosure.

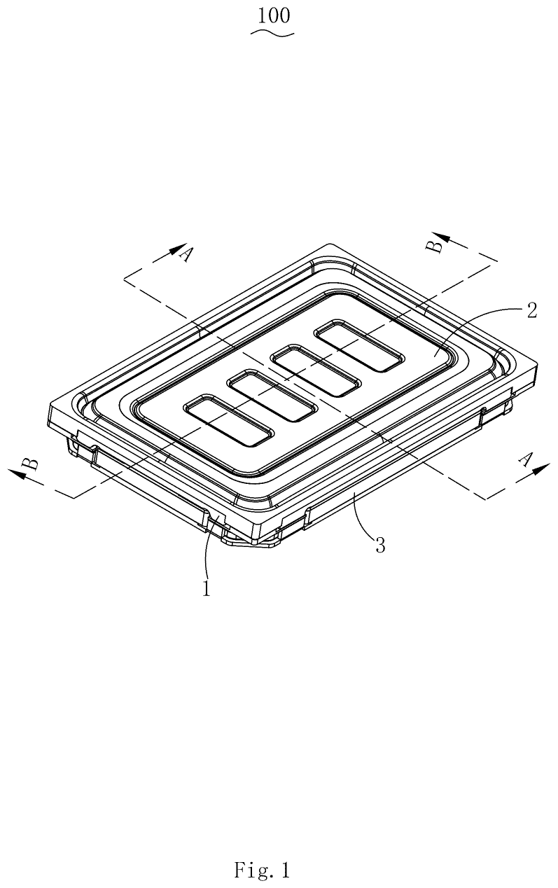

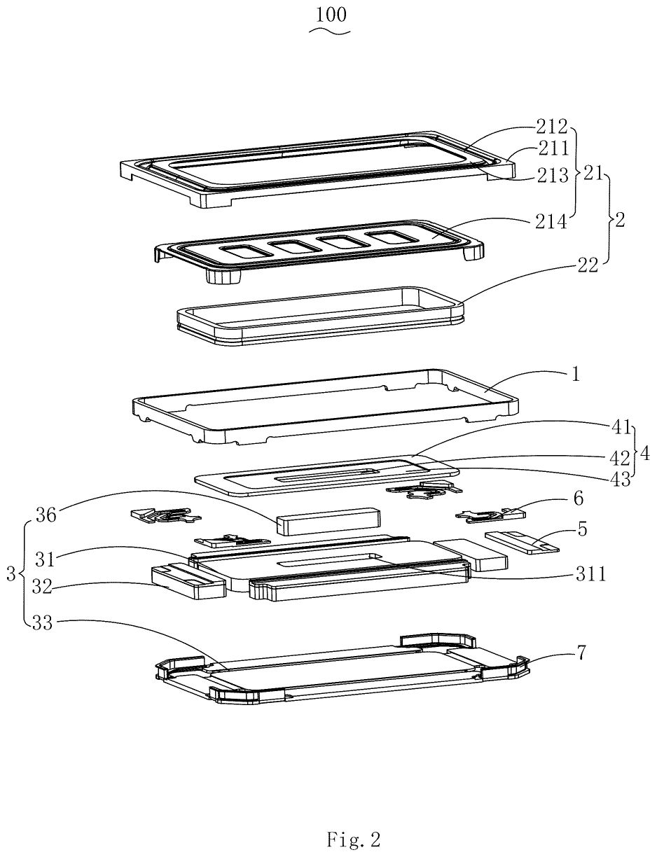

Please refer to FIGS. 1-2 together, a speaker 100 provided by an exemplary embodiment of the present disclosure includes a frame 1, a vibration system 2 mounted on the frame 1, and a magnet system 3 mounted on the frame 1 and spaced apart from the vibration system 2.

Specifically, the vibration system 2 includes a diaphragm 21 mounted on the frame 1, and a coil 22 fixed on the diaphragm 21. The coil 22 is configured to drive the diaphragm 21 to vibrate along a vibration direction for generating sound signal.

The magnet system 3 includes a bottom yoke 33, a main magnet 31 disposed on a surface of the bottom yoke 33 facing the diaphragm 21, a magnetic member 36 disposed on the bottom yoke 33, and a side magnet 32 surrounding the main magnet 31 for forming a magnetic gap 35. To be specific, the main magnet 31 is hollow structure, which includes a first through hole 311 penetrating thereon along the vibration direction. The coil 22 is inserted into the magnetic gap 35. The magnetic member 36 is surrounded by the main magnet 31 so as to form an installation gap 34. In one embodiment, the main magnet 31 is a single rectangular ring-shaped magnet, or formed by a plurality of magnets arranged in an annular manner.

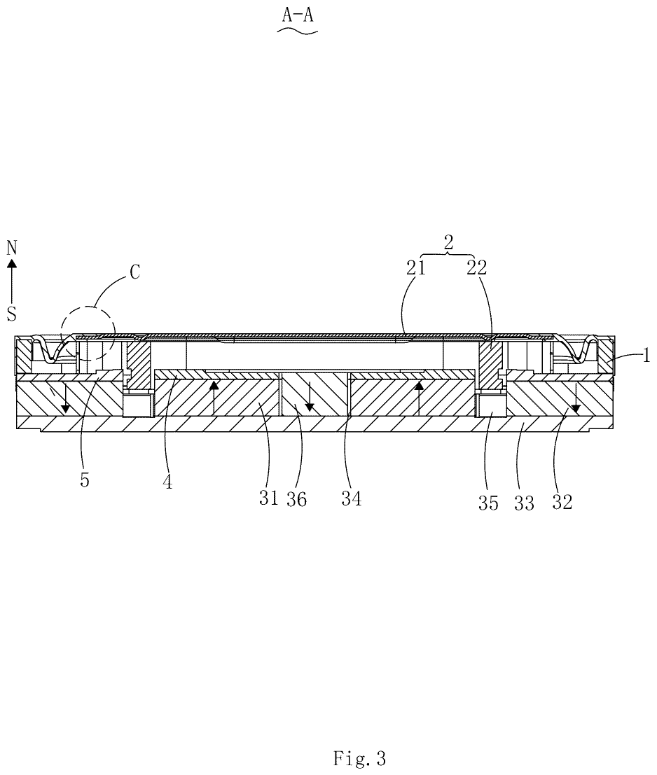

In some embodiments, the magnetic member 36 is made of permanent magnet or magnetically conductive material. As shown in FIG. 3, the side magnet 32 and the magnetic member 36 are magnetized along a same direction parallel to the vibration direction. When the magnetic member 36 is made of permanent magnet, the main magnet 31 is magnetized along a direction opposite to both magnetization directions of the magnetic member 36 and the side magnet 32. Thus, owing to the magnetic member 36, the magnetic field of the main magnet 31 is enclosed, thereby effectively reducing the magnetic flux leakage along the vibration direction and then improving the acoustic quality of the speaker 100.

In one embodiment, referring to FIG. 3, the magnetic pole of the main magnet 31 closer to the diaphragm 21 is N pole, and the magnetic pole of the main magnet 31 closer to the bottom yoke 33 is S pole. The magnetic pole of the side magnet 32 closer to the diaphragm 21 is S pole, and the magnetic pole of the side magnet 32 closer to the bottom yoke 33 is N pole.

Furthermore, as shown in FIG. 2, the magnet system 2 includes four side magnets 32 arranged at intervals. The frame 1 is rectangular. Two of the four side magnets 32 are opposite to each other along a long axis direction, and the other two of the sour side magnet 32 are opposite to each other along a short axis.

Additionally, the magnet system 3 further includes a main magnetic plate 4 stacked on a surface of the main magnet 31 facing the diaphragm 21, and a side magnet plate 5 disposed on a surface of the side magnet 32 facing the diaphragm 21. As shown in FIGS. 2-3, the main magnetic plate 4 is rectangular, and disposed on a surface of the magnetic member 36 facing the diaphragm 21. A surface of the side magnetic plate 5 closer to the diaphragm21 is fixed on the frame 1.

Referring to FIGS. 2-3, the main magnetic plate 4 includes a main body 41 fixed on the main magnet 31, a step portion 43 depressed from a surface of the main body 41 facing the diaphragm 21 towards the bottom yoke 33, and a second through hole 42 penetrating the step portion 43 along the vibration direction. The magnetic member 36 is opposite to the second through hole 42 and extends into the second through hole 42. The second through hole 42 is connected with the installation gap 34. In this manner, not only reduce the magnetic flux leakage of the magnet system 3, but also ensure the magnetic field strength near the coil.

In one embodiment, a surface of the step portion 43 facing the diaphragm 21 is aligned with a surface of the magnetic member 36 facing the diaphragm 21, thus lowering the magnet system 3 and saving installation space. Besides, a width d of the installation gap 36 satisfies the following condition: 0 mm≤d≤5 mm. Accordingly, installation space of the magnet system 3 could be further saved.

Moreover, the diaphragm 21 includes a suspension portion 212 in a rectangular ring shape, a fixation portion 211 extended from an outer edge of the suspension portion 212, a vibration portion 213 extended inwardly from an inner edge of the suspension portion 212, and a central portion 214 fixed on a surface of the vibration portion 213 facing the main magnet 31. The fixation portion 211 is mounted on a surface of the frame 1 away from the bottom yoke 33. The coil 22 is fixed on a surface of the central portion 214 facing the bottom yoke 33.

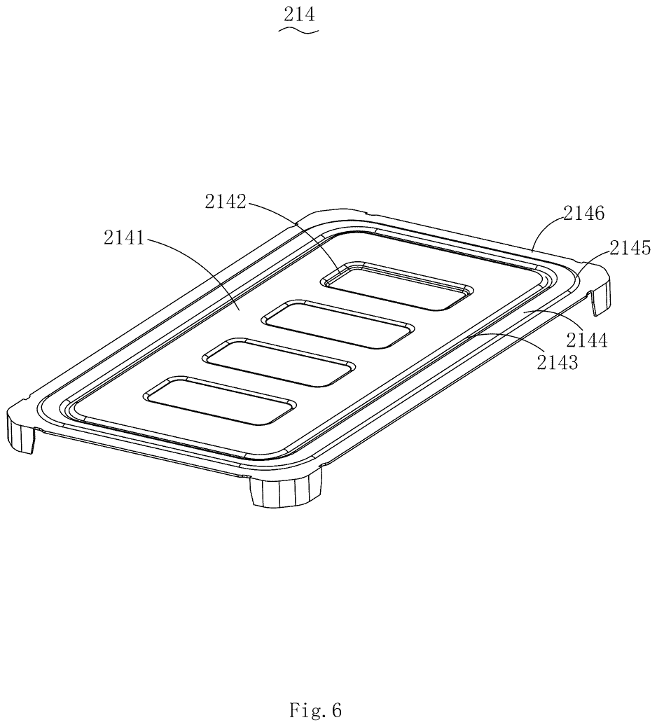

Furthermore, as shown in FIG. 6, the central portion 214 includes an central plate 2141, a plurality of concave portions 2132 depressed from the central plate 2141 towards the main magnet 31, a first bending portion 2143 extended outwardly from the central plate 2141 towards the bottom yoke 33, a first connection portion 2144 extended from outer edge of the first bending portion 2143, a second bending portion 2145 extended from outer edge of the connection portion 2144 towards the bottom yoke 33, and a second connection portion 2146 extended from outer edge of the second bending portion 2145. A side of the second connection portion 2146 away from the central plate 2141 is fixed on the vibration portion 213. The coil 22 is fixed on a side of the first bending portion 2143 facing the bottom yoke 33.

In one embodiment, the central portion 214 includes four concave portions 2132 arranged linearly.

Furthermore, the vibration portion 213 includes a vibration body 2131 fixed to inner edge of the suspension ring 212, a first connection plate 2132 and a second connection plate 2133 extended from the vibration body 2131, and an arc portion 2134 extended from the first connection plate 2132 towards the central portion 214. The first connection plate 2132 and the second connection plate 2133 are spaced apart from each other to form a limitation slot 2135. The second connection portion 2146 is received in the limitation slot 2135. The second bending portion 2145 is abutted to the arc portion 2134. By receiving the second connection portion 2146 in the limitation slot 2135, a surface of the second connection portion 2146 away from the bottom yoke 33 is aligned with a surface of the first connection plate 2132 away from the bottom yoke 33, therefore reducing the height of the diaphragm 21 and saving installation space.

Besides, the speaker 100 includes a circuit board 6 mounted on a side of the frame 1 away from the bottom yoke 33. An end of the circuit board 6 away from the frame 1 is electrically connected to the coil 22. In one embodiment, the speaker 100 includes two circuit boards 6 located on two sides of the coil 22, thus preventing the coil 22 from horizontal weaving and improving reliability.

In one embodiment, the speaker 100 further includes four support portions 7 disposed on four corner portions of the bottom yoke 33. The circuit board 6 is abutted to the four support portions 7, further improving the stability of the circuit boards 6.

It is to be understood, however, that even though numerous characteristics and advantages of the present exemplary embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms where the appended claims are expressed.

What is claimed is:

1. A speaker comprising:
a frame;
a vibration system, comprising:
a diaphragm mounted on the frame; and
a coil fixed on the diaphragm;
a magnet system mounted on the frame, configured to drive the diaphragm to vibrate along a vibration direction for generating sound signal, comprising:
a bottom yoke;
a main magnet disposed on a surface of the bottom yoke facing the diaphragm, including a first through hole penetrating thereon along the vibration direction;
a magnetic member disposed on the bottom yoke, surrounded by the main magnet so as to form an installation gap; and
a side magnet surrounding the main magnet for forming a magnetic gap in which the coil is inserted.

2. The speaker as described in claim 1, wherein the magnetic member is made of permanent magnet or magnetically conductive material.

3. The speaker as described in claim 2, wherein the magnetic member is made of permanent magnet; the main magnet is magnetized along a direction opposite to both magnetization directions of the magnetic member and the side magnet.

4. The speaker as described in claim 3, wherein the main magnet is magnetized along the vibration direction.

5. The speaker as described in claim 1, wherein the magnet system comprises a main magnetic plate stacked on a surface of the main magnet facing the diaphragm.

6. The speaker as described in claim 5, wherein the main magnetic plate is rectangular, and disposed on a surface of the magnetic member facing the diaphragm.

7. The speaker as described in claim 5, wherein the main magnetic plate comprises a main body fixed on the main magnet, a step portion depressed from a surface of the main body facing the diaphragm towards the bottom yoke, and a second through hole penetrating the step portion along the vibration direction; the magnetic member is opposite to the second through hole and extends into the second through hole; the second through hole is connected with the installation gap.

8. The speaker as described in claim 7, wherein a surface of the step portion facing the diaphragm is aligned with a surface of the magnetic member facing the diaphragm.

9. The speaker as described in claim 1, wherein a width d of the installation gap satisfies the following condition: 0 mm≤d≤5 mm.

10. The speaker as described in claim 1, further comprising a side magnet plate disposed on a surface of the side magnet facing the diaphragm; a surface of the side magnetic plate closer to the diaphragm is fixed on the frame.

11. The speaker as described in claim 1, the diaphragm comprises a suspension portion in a rectangular ring shape, a fixation portion extended from an outer edge of the suspension portion, a vibration portion extended inwardly from an inner edge of the suspension portion, and a central portion fixed on a surface of the vibration portion facing the main magnet; the fixation portion is mounted on a surface of the frame away from the bottom yoke; the coil is fixed on a surface of the central portion facing the bottom yoke.
